(19) United States
(12) Patent Application Publication
(10) Pub. No.: US 2011/0090409 A1
(43) Pub. Date: Apr. 21, 2011

(54) Projection Image Display Apparatus with Multi-Window Display Capability

(75) Inventors: Kenya KAWASAKI, Osaka (JP); Kenji OFUNE, Osaka (JP)

(73) Assignee: Sanyo Electric Co., Ltd., Osaka (JP)

(21) Appl. No.: 12/908,448

(22) Filed: Oct. 20, 2010

(30) Foreign Application Priority Data
Oct. 20, 2009 (JP) 2009-241400 P

(51) Int. Cl. H04N 9/31

(52) U.S. Cl. 348/744; 348/E09.025

(57) ABSTRACT

A projector including an input unit which includes 1 (1 is a natural number) input ports and receives n (n is a natural number not more than 1) image signals supplied from n image-signal supplying devices, respectively via n input ports, a display unit which selects two image signals from the n image signals received by the input unit and displays images based on these two image signals respectively on a main window and a subwindow, and a notification unit which displays a notification image which gives notification about information regarding the two image signals, on a blank area of a image display area of the display unit.

### CROSS REFERENCE OF RELATED APPLICATION

This nonprovisional application is based on Japanese Patent Application No. 2009-241400 filed on Oct. 20, 2009 with the Japan Patent Office, the entire contents of which are hereby incorporated by reference.

### BACKGROUND OF THE INVENTION

1. Field of the Invention

The present invention relates to a projection image display apparatus, and more specifically to a projection image display apparatus which simultaneously displays a plurality of images on the same screen.

2. Description of the Related Art

For a projection image display apparatus (hereinafter also referred to as projector) having a plurality of image input ports, a configuration equipped with an image display apparatus capable of displaying all input images as moving images has been disclosed.

This image display apparatus is provided with a touch-panel device for switching image inputs, and a projection image output of the projector is selected with the device for switching image inputs. This allows for check of all input statuses during projection of a certain image and in an idling status.

Another example of such a projector with a plurality of image-signal input ports is a projector which includes an image reproducing unit for reading information recorded on an recording medium and outputting a first image signal based on the information, and an image-signal input unit for receiving input of a second image signal from an external image-outputting device.

The above-described projector detects whether or not there is an input of the second image signal to the image signal input unit. If the projector detects that the input of the second image signal has been initiated while the image reproducing unit is reproducing the first image signal, then the projector stops reproduction of the first image signal and makes an input selecting unit select the second image signal. With such a configuration, a user can make a switch from a reproduction image to an external input image by performing an operation of making the external image-outputting device output an image. Thus, an operation for switching input sources is no longer required, and a simplified operation in switching images can be achieved.

In a projector with a plurality of input ports as described above, the diversification of types of external signal-supplying devices in recent years tends to increase the number of input ports in a projector body receiving image signals from the signal supplying devices.

Further, in a projector with a plurality of input ports, a projector with a function of simultaneously displaying a plurality of images on the same screen is under study.

For example, consider a case of a projector with four input ports, where images are displayed by a double-window display function for simultaneously displaying two images. In this case, in the projector, two images to be displayed respectively on two windows are switched according to a combination of image signals of two of the four input ports.

In order to perform such image-signal switching in the above-described projectors, there is a possibility of complication of a configuration of the image-input switching device. Further, each input port requires an image-signal detecting unit for detecting whether or not there is an input of an image signal to the image signal input unit, which causes a problem of complication of a control configuration for switching images. Therefore, there is a need for achieving simplification of operation in simultaneously displaying a plurality of images with a simple device configuration.

### SUMMARY OF THE INVENTION

An object of the present invention is to provide a projection image display apparatus in which enhanced usability in simultaneously displaying a plurality of images on the same screen can be achieved with a simple configuration.

A projection image display apparatus according to an aspect of the present invention includes an input unit which includes 1 (1 is a natural number) input ports and receives n (n is a natural number not more than 1) image signals supplied from n image-signal supplying devices, respectively via n input ports, a display unit which selects m (m is a natural number not more than n) image signals of the n image signals received by the input unit and displays images based on the m image signals respectively on m display areas, and a notification unit which displays a notification image which gives notification about information regarding at least one image signal of the m image signals, on a blank area outside the m display areas in an image display area of the display unit.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 illustrates a configuration of peripheral equipment when projecting an image with a projection image display apparatus according to an embodiment of the present invention.

FIG. 2 shows a configuration of a projector in FIG. 1.

FIG. 3 is a detailed view of a portion of FIG. 2.

FIG. 4 shows an example of an image displayed by the projector according to the present embodiment.

FIG. 5 shows an example of an image displayed by the projector according to the present embodiment.

FIG. 6 shows another example of an image displayed by the projector according to the present embodiment.

FIG. 7 shows another example of an image displayed by the projector according to the present embodiment.

### DESCRIPTION OF THE PREFERRED EMBODIMENT

An embodiment of the present invention will be hereinafter described in detail with reference to the drawings. It is noted that in the drawings, the same or corresponding elements have the same signs allotted, and description thereof will not be repeated.

FIG. 1 illustrates a configuration of peripheral equipment when projecting an image with a projection image display apparatus according to an embodiment of the present invention.

Referring to FIG. 1, a projection image display apparatus 1 (hereinafter also referred to as “projector”) according to the present embodiment is a liquid crystal projector which utilizes a liquid crystal device to project an image and projects (displays) an image by projecting, onto a screen 6, light of an image displayed by the liquid crystal device. A projection surface is not limited to screen 6, and may be the surface of a wall.

Projector 1 includes a remote control receiving unit 20 which receives an infrared-modulated remote-control signal sent from a remote control 4 operated by a user and an input unit 9. The remote control signal includes a command signal for remotely controlling projector 1. Input unit 9 includes a plurality of input ports, from which different types of image signals can be inputted. It is noted that in the present embodiment, it is assumed for simplicity's sake that there are two external image-signal supplying devices and that input unit 9 includes two input ports corresponding to these image-signal supplying devices 2D and 2A.

To input unit 9, a digital transmission line 3 and an analog transmission line 7 are connected. Digital transmission line 3 includes an HDMI (High Definition Multimedia Interface) cable. The HDMI cable transmits a signal conforming to EDAM between external digital-signal supplying device 2D and projector 1. A communication cable is connected to an input port of input unit 9. Although the digital transmission line here is a path which transmits data and a signal in conformity with HDMI, the digital transmission line may be a transmission path conforming to DVI (Digital Visual Interface).

Analog transmission line 7 includes a wired or wireless transmission line. The transmission line transmits a signal between analog-signal supplying device 2A and projector 1. Analog transmission line 7 is connected to the input port of input unit 9. Here, digital-signal supplying device 2D is assumed to be a digital-signal supplying device, such as a DVD (Digital Versatile Disc) player and a Blu-ray disc player, which outputs a digital signal, and analog-signal supplying device 2A is assumed to be a device, such as a computer, which outputs an analog signal.

For simplicity of explanation, the analog signal transmitted from analog-signal supplying device 2A is assumed to be an image signal, and the digital signal supplied from digital-signal supplying device 2D is assumed to be an image signal. With these image signals, an audio signal is also transmitted, however, for simplicity of explanation, explanation of transmission of the audio signal and audio signal processing in projector 1 will not be given.

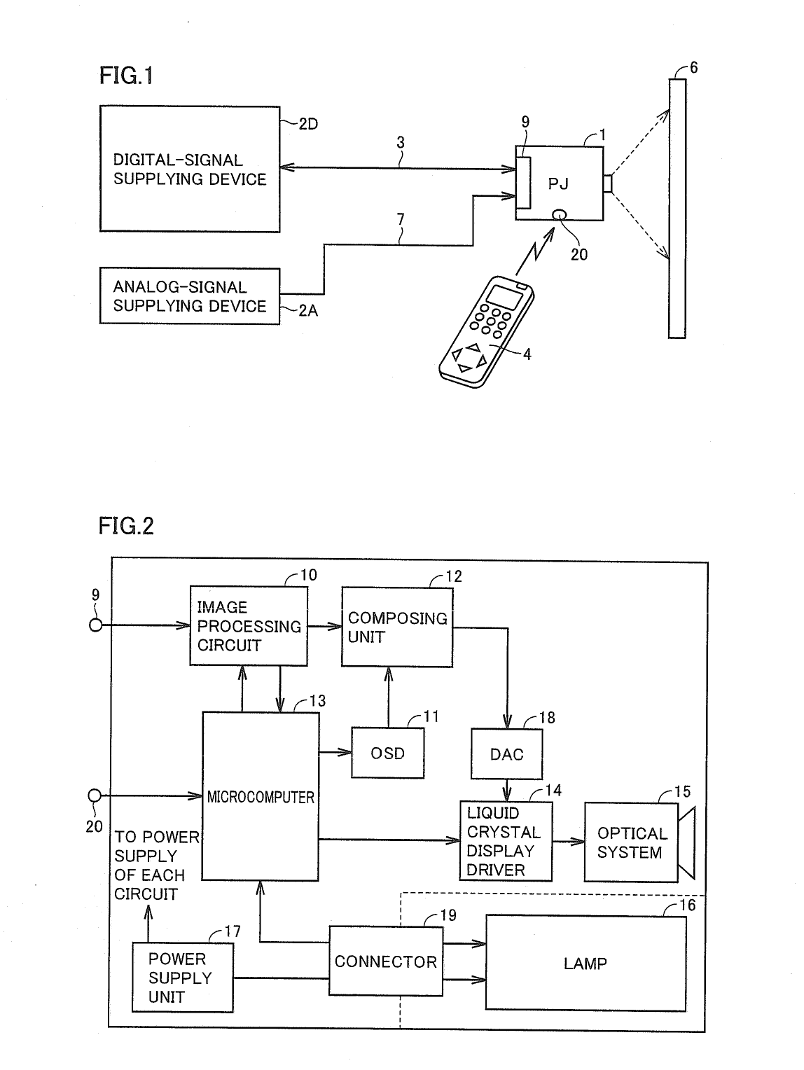

FIG. 2 shows a configuration of projector 1 in FIG. 1.

Referring to FIG. 2, projector 1 includes an image-processing circuit 10, an OSD (On Screen Display) circuit 11, a composing unit 12, a DAC (Digital Analog Converter) 18, a microcomputer 13, a liquid crystal display driver 14, an optical system 15, a power supply unit 17, a connector 19, and a lamp 16.

Microcomputer 13 generates a control command based on a command signal inputted from remote control 4 (FIG. 1) via remote control receiving unit 20 and outputs the signal to each unit of projector 1.

Image-processing circuit 10 processes an image signal inputted from input unit 9 into a signal for display and outputs the signal. Specifically, image-processing circuit 10 writes an image signal from input unit 9 into a frame memory (not shown) on a frame by frame (screen by screen) basis, and reads an image stored in the frame memory. Further, a variety of image processings is performed during these write and read processings, thereby converting the inputted image signal to generate image data which is an image signal for projection.

In accordance with instructions from microcomputer 13, OSD circuit 11 generates, as an OSD image signal, a character or symbol indicating a variety of status of projector 1, a menu image for correcting an image distortion, adjusting an image quality, and setting operation conditions, for example, and a decorated image such as a pointer image and an underlined image (these images are hereinafter also referred to as “OSD image”), and outputs the signal to composing unit 12.

Composing unit 12 combines the OSD image signal with the image signal outputted from image-processing circuit 10, generates image data as a composite image signal, and supplies it to DAC 18.

Here, the OSD image signal is generated when a user instructs to display the OSD image from remote control 4 and by OSD circuit 11 reading OSD data stored in a memory. It is noted that when the OSD image is not to be displayed, composing unit 12 does not perform the above-described composing processing and the image data outputted from image-processing circuit 10 is supplied to DAC 18 on an as is basis.

DAC 18 receives the image signal outputted from composing unit 12 and converts the image signal into an analog signal to output it to liquid crystal display driver 14.

Liquid crystal display driver 14, optical system 15, and lamp 16 correspond to a display unit which displays an image on screen 6 based on the image signal outputted from DAC 18 and under control of microcomputer 13.

Operation of the display unit will be described. Lamp 16, which is an illuminating device, is formed of, for example, an ultra-high-pressure mercury lamp, a metal halide lamp, a xenon lamp, or the like. Lamp 16 is removably attached to projector 1 via connector 19. From lamp 16, light is emitted in a form of approximately parallel light to liquid crystal display driver 14.

Liquid crystal display driver 14 includes an optical system including a lens and a prism which are not shown in the drawings, and liquid crystal panels for R, G and B, respectively. In liquid crystal display driver 14, light from lamp 16 passing through an interior lens system which is not shown in the drawings, is incident on the liquid crystal panels for R, G and B in such a manner that the distribution of the amount of light is uniform. The light incident via the lens system includes light in a blue wavelength range (hereinafter referred to as “B light”), light in a red wavelength range (hereinafter referred to as “R light”), and light in a green wavelength range (hereinafter referred to as “G light”) which are incident on liquid crystal panels for R, G and B, respectively, as approximately parallel light. Liquid crystal panels are driven in response to image signals which correspond to R, G and B and are fed from DAC 18, and modulate light depending on their drive status. R light, G light and B light modulated by the liquid crystal panels are colour synthesized by a dichroic prism before projected in an enlarged manner on screen 6 by a projection lens. The projection lens includes a group of lenses for allowing projected light to provide an image on screen 6 and an actuator for varying a part of the group of lenses in a direction of the optical axis to adjust a zoom status and a focus status of a projected image.

Power supply unit 17 is supplied with power via a plug (not shown) inserted into a receptacle (not shown) of AC (Alternating Current) power supply to supply the supplied power to each unit within projector 1.

A user can use remote control 4 to make a variety of inputs. The remote control signal sent from remote control 4 is inputted via remote control receiving unit 20 to microcomputer 13, and a variety of corresponding processings is performed.

As one of these processings, projector 1 according to the present embodiment has a function of selecting analog and digital signals respectively inputted from two input ports of input unit 9 and displaying an image based on the analog signal and an image based on the digital image respectively on two display areas (hereinafter also referred to as double-window display function).

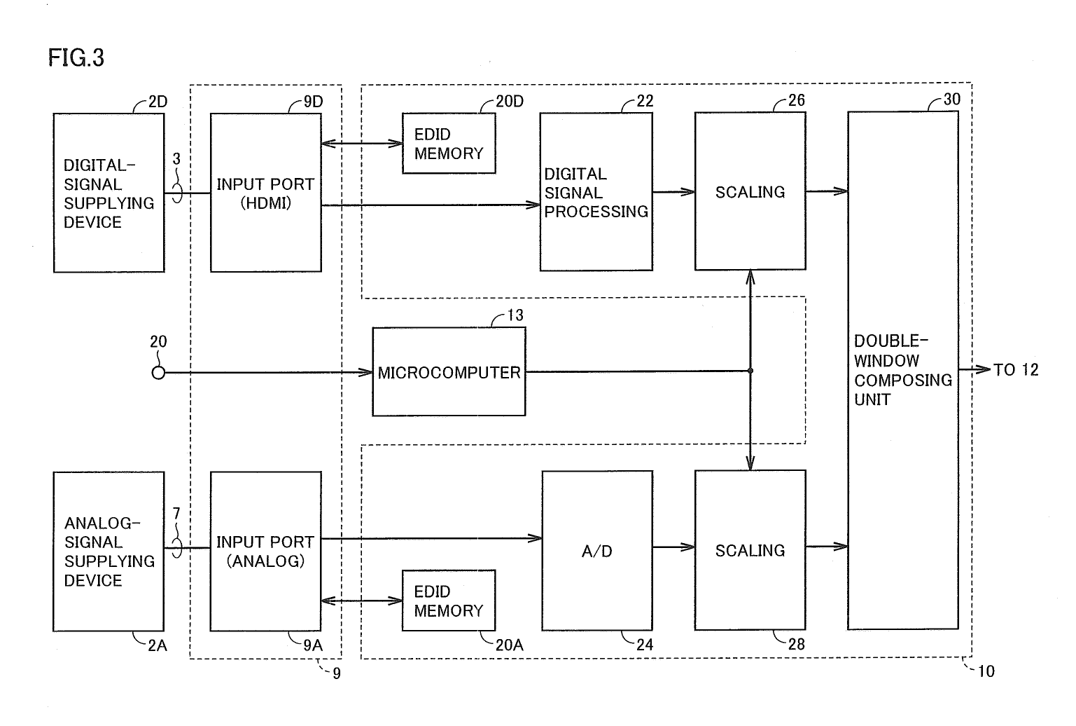

Referring to FIG. 3, a double-window display function of projector 1 according to the present embodiment will be hereinafter described.

FIG. 3 is a detailed view of a portion of FIG. 2 (input unit 9 and image-processing circuit 10).

Referring to FIG. 3, input unit 9 includes input ports 9D, 9A. To input port 9D, digital-signal supplying device 2D is connected by the HDMI cable of digital transmission line 3. To input port 9A, analog-signal supplying device 2A is connected by the (wired or wireless) transmission line of analog transmission line 7. Each input port is supplied with an analog or digital image signal from connected analog or digital-signal supplying device 2A or 2D. Each input port inputs the supplied image signal to image-processing circuit 10.

Image-processing circuit 10 includes EDID (Extended Display Identification Data) memories 20D, 20A for storing EDID information indicating display capability and specifications of projector 1, a digital signal processing unit 22, scaling units 26, 28, an A/D converter 24, and a double-window composing unit 30. It is noted that EDID information includes, as indications of display capability and specifications of projector 1, a displayable resolution (information on an image), audio stream information (information on audio such as an audio format), equipment specific information such as a production number, and the like.

EDID memory 20D is a nonvolatile memory in which EDID information corresponding to a digital image signal is written. EDID memory 20D is connected to input port 9D and EDID information corresponding to a digital image signal can be sent to digital-signal supplying device 2D when input port 9D is connected to digital-signal supplying device 2D via digital transmission line 3.

EDID memory 20A is a nonvolatile memory in which EDID information corresponding to an analog image signal is written. EDID memory 20A is connected to input port 9A and EDID information corresponding to an analog image signal can be sent to analog-signal supplying device 2A when input port 9A is connected to analog-signal supplying device 2A via analog transmission line 7. Digital signal processing unit 22 processes the digital image signal inputted from input port 9D into a signal for display and outputs the signal. Specifically, digital signal processing unit 22 writes the digital image signal into the frame memory (not shown) on a frame by frame (screen by screen) basis, and reads an image stored in the frame memory. Further, a variety of image processings is performed during these write and read processings, thereby converting the inputted digital image signal to generate the image data which is the image signal for display.

Scaling unit 26 converts a resolution of an image represented by the digital image signal, with reference to the resolution of the display unit (hereinafter also referred to as “reference display size”) depending on a preset display size per window which is not more than the reference display size. This resolution conversion allows scaling unit 26 to generate image data representing an image having a resolution not more than the resolution of the display unit.

A/D converter 24 converts the analog image signal inputted from input port 9A into a digital signal and outputs the converted signal to scaling unit 28.

Scaling unit 28 converts a resolution of an image represented by the analog image signal, depending on a preset display size per window which is not more than the reference display size. This resolution conversion allows scaling unit 28 to generate image data representing an image having a resolution not more than the resolution of the display unit.

The image data generated in scaling unit 26 and scaling unit 28 are fed to double-window composing unit 30. Double-window composing unit 30 composes a digital image signal for one frame to be displayed on screen 6, based on the fed two pieces of data. The image signal for one frame, which is obtained by composition, is outputted to composing unit 12 (FIG. 2).

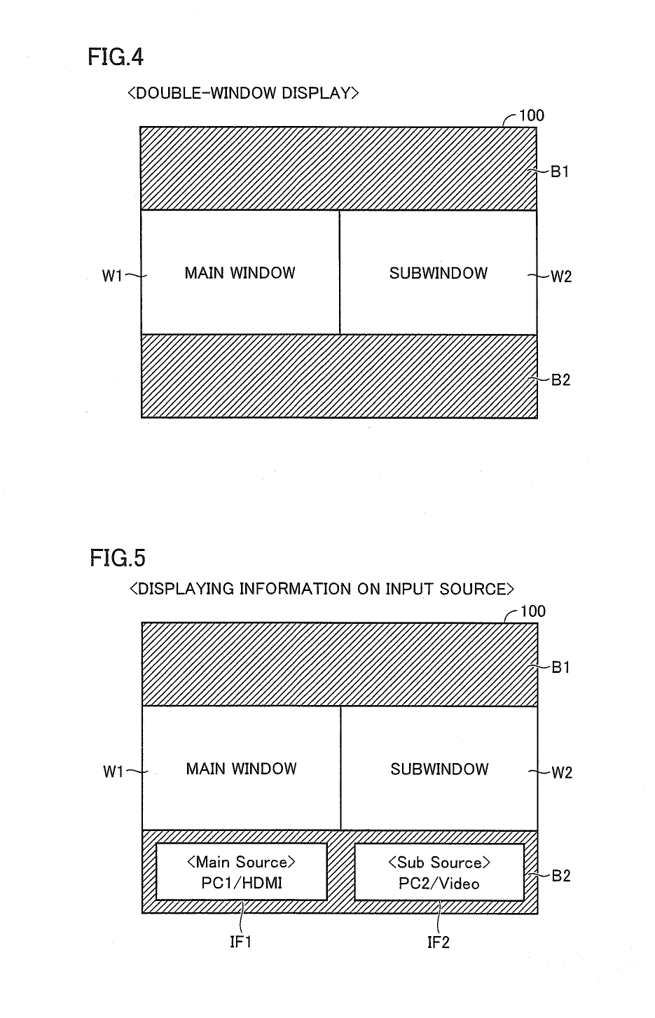

According to FIG. 3, an image signal fed to input port 9D and an image signal fed to input port 9A can be simultaneously displayed. FIG. 4 shows an example of an image displayed by projector 1 of the present embodiment. Referring to FIG. 4, a display area 100 on which the display unit (liquid crystal panel) is to display an image includes a display area W1 (hereinafter also referred to as main window) for displaying one of two images and a display area W2 (hereinafter also referred to as subwindow) for displaying the other of two images.

In the example of FIG. 4, main window W1 and subwindow W2 have the same display size which corresponds to approximately one fourth of the size of the display area 100. Further, when main window W1 and subwindow W2 are arranged in a laterally parallel manner as in FIG. 4, display area 100 includes upper and lower portions between which main window W1 and subwindow W2 are interposed and on which blank areas B1, B2 displaying no image are formed, respectively. Heretofore, blank areas B1, B2 have been commonly painted all in a background colour or the like preset by a user, and thus not effectively utilized. Project according to the present embodiment utilizes these blank areas B1, B2 to display, simultaneously with display of main window W1 and subwindow W2, notification images for giving notification about information regarding image signals displayed on main window W1 and subwindow W2.

Specifically, referring to FIG. 2, microcomputer 13 communicates with image-processing circuit 10 to obtain information regarding image signals of input ports 9D and 9A. Microcomputer 13 then generates a signal representing the obtained information regarding image signals and outputs it to OSD circuit 11. Based on the signal fed from microcomputer 13, OSD circuit 11 generates the OSD image signal, and outputs it to composing unit 12.

Composing unit 12 combines the OSD image signal with the image signal outputted from image-processing circuit 10 (double-window composing unit 30), generates image data as a composite image signal, and supplies it to DAC 18. This results in that the notification images representing information regarding image signals displayed on main window W1 and subwindow W2 are displayed along with display of main window W1 and subwindow W2.

This allows a user to directly obtain desired information regarding an image signal without performing operation for obtaining information regarding an image signal. As a result, enhanced usability in double-window display can be achieved.

FIG. 5 shows an example of an image displayed by projector 1 according to the present embodiment.

Referring to FIG. 5, simultaneously with display of two images respectively on main window W1 and subwindow W2, on blank area B2, a notification image IF1 giving notification about information regarding an input source of the image displayed on main window W1 and a notification image IF2 giving notification about information regarding an input source of the image displayed on subwindow W2 are displayed in association with main window W1 and subwindow W2, respectively.

The information regarding an input source of an image includes, for example, the type of an external signal-supplying device which is a source of the image displayed on each window and the type of an image signal. In the example of FIG. 5, it is displayed as notification image IF 1 that the image displayed on main window W1 is supplied from a PC (Personal Computer) 1 and based on an image signal transmitted in conformity with HDMI. Further, it is displayed as notification image IF2 that the image displayed on subwindow W2 is supplied from PC2 and based on Video signals.

It is noted that the manner of display is not limited to that of the example of FIG. 5, and may be such that a valid signal-supplying device and an invalid signal-supplying device of a plurality of external signal-supplying devices are displayed with a colour-coded distinction.

With such a configuration, a user can directly keep track of to which input port of a plurality of input ports provided on projector 1 an image signal is being inputted, rather than through an operation such as visually checking input unit 9 or displaying a menu screen by projection by means of OSD circuit 11. In particular, its merit is remarkable in a projector having a number of input ports due to diversification of signal supplying devices, and enhanced usability in double-window display can be achieved.

Other Configurations

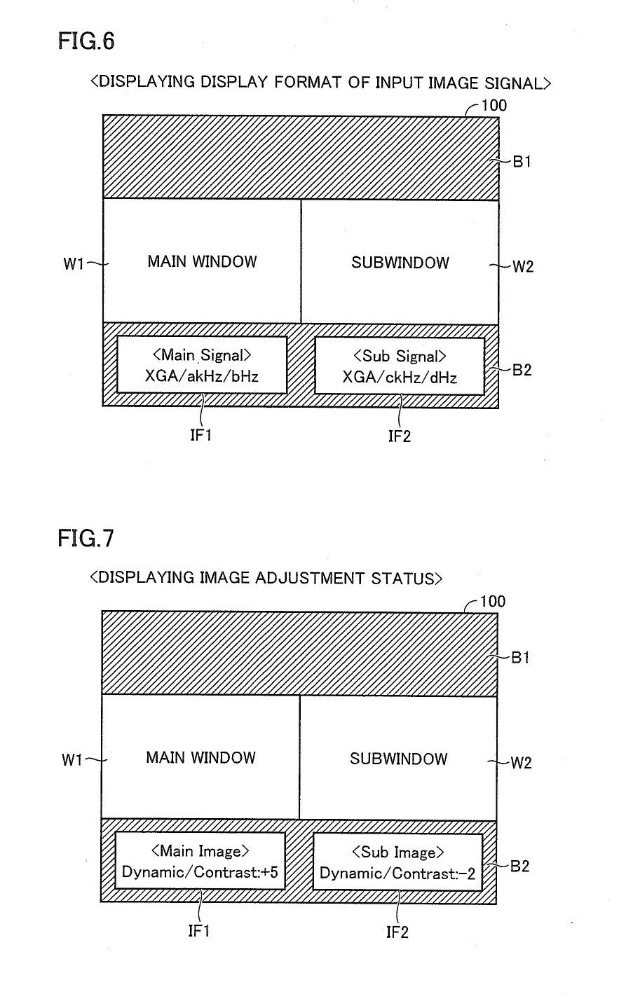

FIG. 6 shows another example of an image displayed by projector 1 according to the present embodiment.

Referring to FIG. 6, simultaneously with display of two images respectively on main window W1 and subwindow W2, on blank area B2, a notification image IF1 giving notification about information regarding a display format of the image displayed on main window W1 and a notification image IF2 giving notification about information regarding a display format of the image displayed on subwindow W2 are displayed in association with main window W1 and subwindow W2, respectively.

The information regarding a display format of an image includes, for example, the resolution and the input synchronization frequency (horizontal synchronization frequency, vertical synchronization frequency) of an input image signal corresponding to the image displayed on each window. In the example of FIG. 6, it is displayed as notification image IF1 that the input image signal corresponding to the image displayed on main window W1 has a resolution of XGA (1024×768 pixels), a horizontal synchronization frequency of a kHz, and a vertical synchronization frequency of b Hz.

Further, it is displayed as notification image LF2 that the input image signal corresponding to the image displayed on subwindow W2 has a resolution of XGA, a horizontal synchronization frequency of c kHz, and a vertical synchronization frequency of d Hz.

Usually, information regarding a display format of an image is obtained after a user performs an operation of making a menu screen displayed by projection or on an operation panel provided on a body of projector 1. In contrast, in projector 1 according to the present embodiment, such information is displayed utilizing the blank areas, which allows a user to directly keep track of a display format of an image rather than through the above-described operation.

FIG. 7 shows another example of an image displayed by projector 1 according to the present embodiment.

Referring to FIG. 7, simultaneously with display of two images respectively on main window W1 and subwindow W2, on blank area B2, a notification image IF1 giving notification about information regarding display image quality of the image displayed on main window W1 and a notification image IF2 giving notification about information regarding display image quality of the image displayed on subwindow W2 are displayed in association with main window WI and subwindow, W2, respectively.

The information regarding display image quality of an image includes, for example, image quality adjustment parameters, such as sharpness, brightness and contrast of the image displayed on each window. In the example of FIG. 7, parameters relating to the brightness and the contrast of the image displayed on main window WI are displayed as notification image IF1. Further, parameters relating to the brightness and the contrast of the image displayed on subwindow W2 are displayed as notification image IF2.

When adjusting image quality with two windows displayed, it is confusing for a user whether a change in a parameter affects either one of main window W1 and subwindow W2 or both of main window W1 and subwindow W2, and consequently, operation required for adjustment could be complicated. According to projector 1 of the present embodiment, such troubles can be resolved because adjustment parameters for display image quality of each window are displayed in association with an image, and enhanced operability in adjusting image quality can be achieved.

It is noted that in the present embodiment, an arrangement of display areas (windows) displaying different image signals are not limited to be in a laterally parallel manner as in FIGS. 4-7, and may be in a vertically parallel manner. Further, the display areas may have the same size as in FIGS. 4-7, or may have different sizes. Further, the image displayed on each display area is applicable to both a moving image and a still image.

Further, in the present embodiment, while double-window display in which two input ports are provided and two different image signals are displayed on screen 6 has been described by way of example, the present embodiment is not limited thereto. Rather, the present embodiment is widely applicable to multi-window display in which 1 (1 is a natural number not less than 2) input ports are provided and m (m is a natural number not more than n) different image signals of n (n is a natural number not more than 1) image signals inputted via n input ports are simultaneously displayed.

Further, while the present embodiment employs a liquid crystal projector as a projector, the present embodiment is not limited thereto. For example, the technology of the present invention may be employed in a projector using other method, such as a DLP (Digital Light Processing®) projector.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A projection image display apparatus, comprising:
an input unit which includes 1 (1 is a natural number) input ports and receives n (n is a natural number not more than 1) image signals supplied from n image-signal supplying devices, respectively via n input ports;
a display unit which selects m (m is a natural number not more than n) image signals of said n image signals received by said input unit and displays images based on said m image signals respectively on m display areas; and
a notification unit which displays a notification image which gives notification about information regarding at least one image signal of said m image signals, on a blank area outside said m display areas in an image display area of said display unit.

2. The projection image display apparatus according to claim 1, wherein
said information regarding at least one image signal includes information regarding a type of at least one image-signal supplying device each supplying said at least one image signal.

3. The projection image display apparatus according to claim 1, wherein
said information regarding at least one image signal includes information regarding a display format of said at least one image signal.

4. The projection image display apparatus according to claim 1, wherein
said information regarding at least one image signal includes information regarding display image quality of said at least one image signal.
